(19) United States
(12) Patent Application Publication
(10) Pub. No.: US 2004/0049463 A1
(43) Pub. Date: Mar. 11, 2004

(54) Method for preventing forgery of every kinds of lottery-ticket, exchange-ticket, certificate published by communication network and id-card, credit-card, medical insurance card with authentication code

(76) Inventor: Oh-Bong Kwon, Icheon (KR)

Correspondence Address: Peter T Kwon, Kangnam P O Box 2301, Seoul, 135-242, KR

(21) Appl. No.: 10/470,529

(22) PCT Filed: Jan. 31, 2002
(86) PCT No.: PCT/KR02/00146

(30) Foreign Application Priority Data
Feb. 1, 2001 (KR) 2001/4862

(51) Int. Cl. G06F 17/60

(52) U.S. Cl. 705/50

(57) ABSTRACT

The present invention relates a method of preventing forgery/alteration of securities and certification documents issued by communication networks and personal identification, financial transaction and medical insurance cards with certification codes in which the necessary information pertaining to the identification of an owner and issued material is encrypted and attached to the issued materials in order to prevent an unauthorized use or operation of the issued materials through the Internet, ARS services or communication networks.

### BACKGROUND OF THE INVENTION

1. Field of the Invention

The present invention relates to a method of preventing forgery/alteration of securities and certification documents issued through communication networks and personal identification, financial transaction and medical insurance cards with certification codes. More particularly, the invention relates a method of preventing forgery/alteration of securities and certification documents issued through communication networks and personal identification, financial transaction and medical insurance cards with certification codes in which the necessary information pertaining to the identification of owners and issued materials is encrypted and attached to the issued materials in order to prevent an unauthorized use or illegal operation of the issued materials through communication networks.

2. Description of the Prior Art

With the rapid development of computer processing and communication network technology as well as a significant increase in the use of the Internet by the public, the issuance of lottery tickets, securities and various certification documents (i.e., certificate of graduation, certificate of academic record) through online services such as the Internet or Automatic Reply Service (ARS) are now available.

The issuance of securities through these online services are unrestrained by the time and location factors and the users of the services can conveniently request and obtain the required services. In case of lottery type securities (lottery tickets, betting tickets, gift certificates), the users' selection can be widened by allowing the users to select lottery numbers directly. As for the issuing institutions, the cost is saved by reducing the cost of issuance on paper.

In spite of these advantages, the issuance of securities or certification documents through online services (Internet or other communication networks) is prone to an unauthorized falsification of the contents (contents of certification documents or lottery numbers) through a skilled manipulation of computer processing technology. Moreover, it is not easy for the recipient of the documents to verify the faithfulness of the contents. As a result, the implementation of online services for issuing lottery tickets or certification documents directly to the users has a number of difficulties.

Accordingly, the online services concerning the traditional betting tickets and lottery tickets accept only the request of the above tickets from the users. In practice, for the case of a small number of orders, the web administrator purchases the tickets on behalf of the users and dispatches them to the users only when the lottery has been won. For the case of a large number orders, the corresponding lottery tickets are purchased in bulk and are dispatched to the users through the postal service or couriers.

Due to the security concerns in terms of an unauthorized operation or information leak of the contents of certification documents, the online services, which issue various certification documents such as resident registration document, certified seal registration, proof of tax payment, certificate of graduation, certificate of academic record for the students and citizens, are very limited in that presently they can only deliver the corresponding documents to the person who requests a service through the postal service after receiving the request through the Internet or ARS. These online services can not be regard as the true online services. They merely provide a certain degree of convenience for the users during the requesting stage. Also, they have a number of problems concerning the delay in issuance due to the use of postal delivery and the cost involved with such delivery. The lottery tickets, betting tickets and gift certificates which are issued on paper are prone to loss and damage therefore requiring a further reissue.

In case of financial transaction cards or personal identification cards including a resident registration card, driving license and passport, there is no means for verifying the faithfulness of their contents, as a result, an unauthorized operation and forgery/alteration might occur frequently. Especially, the conventional credit card has a limit in determining a true owner since it only contains a signature means and photographic information for personal identification. The loss or theft of a credit card could bring about a huge loss to its owner.

Also, in case of medical insurance cards, illegal requests of medical bills by medical service providers (i.e., hospital) to the public medical insurance corporation out of falsified medical services are occurring frequently. Presently, the public medical insurance corporation is unable to search out these illegal medical service providers.

### SUMMARY OF THE INVENTION

The present invention is designed to overcome the above problems of prior art. The object of the present invention is to provide a method of preventing an unauthorized use or forgery/alteration of the contents of securities and certification documents issued by communication networks. Another object of the present invention is to provide personal identification, financial transaction and medical insurance cards with certification codes which can prevent an unauthorized use or illegal operation of such cards.

According to the present invention, the method of preventing an unauthorized use or forgery/alteration of the contents of securities issued through communication networks in which the securities are issued to the users through the Internet or ARS and the faithfulness of the contents are authenticated, comprises the steps of: receiving an issuance request of a security through a security issue system from a user via a communication network after obtaining some information about the owner and the requested security; authorizing the cost of the issuance of the security by the security issue system through an online financial institution; constructing a database of the ownership and the requested security after encrypting the information pertaining to the uniqueness of said security and identification of owner and issuing the security to the user; outputting said issued security by the user via a communication network, and authenticating the faithfulness of the security and the owner of said security by a security receiving system in terms of recognizing the code of said security in connection with said security issue system via a computer network.

Also, according to the present invention, the method of preventing an unauthorized use or forgery/alteration of the contents of certification documents issued by communication networks in which certification documents are issued to the users through the Internet or ARS and the faithfulness of the contents are authenticated, comprises the steps of: receiving an issuance request of a security for a certification document issue system from a user via a communication network after obtaining some information about the owner and the requested certification document; authorizing the cost of issuance of said document from the user through an online financial institution; issuing said document to the user in which the essential contents of certification and user information are encrypted; outputting said issued certification document by the user via communication network; and determining the faithfulness of the encrypted information and text by a certification document receiving system by recognizing the encrypted information in connection with the certification document issue system.

Also, in order to accommodate the other object of the present invention, the identification card with certification codes according to the present invention contains an encrypted information pertaining to the personal information and biological information of the user.

Also, the financial transaction card with certification codes according to the present invention contains an encrypted information pertaining to the personal information, bank account information and biological information of the user. At the time of usage, the encrypted information is decrypted by an encryption recognition system and the faithfulness is confirmed through the issuing system. The faithfulness is also determined by comparing the biological information contained in the card with the same information directly obtained from the user who is presently using the card.

Also, the medical insurance card with certification codes according to the present invention contains an encrypted information pertaining to the personal information, card information and version information.

### BRIEF DESCRIPTION OF THE DRAWINGS

FIG. 1 is a block diagram which illustrates a brief construction of the various type of securities issuance and forgery/alteration prevention system according to the present invention.

FIG. 2 is a flow diagram which shows the distribution process of the various type of securities issued through the communication network according to the present invention.

FIG. 3 is a block diagram which illustrates a brief construction of the various type of certification documents issuance and forgery/alteration prevention system according to the present invention.

FIG. 4 is a flow diagram which shows the distribution process of the various type of certification documents issued through the communication network according to the present invention.

FIG. 5 is a block diagram which shows the distribution process of a financial transaction card with certification codes according to the present invention.

### DETAILED DESCRIPTION OF THE PREFERRED EMBODIMENTS

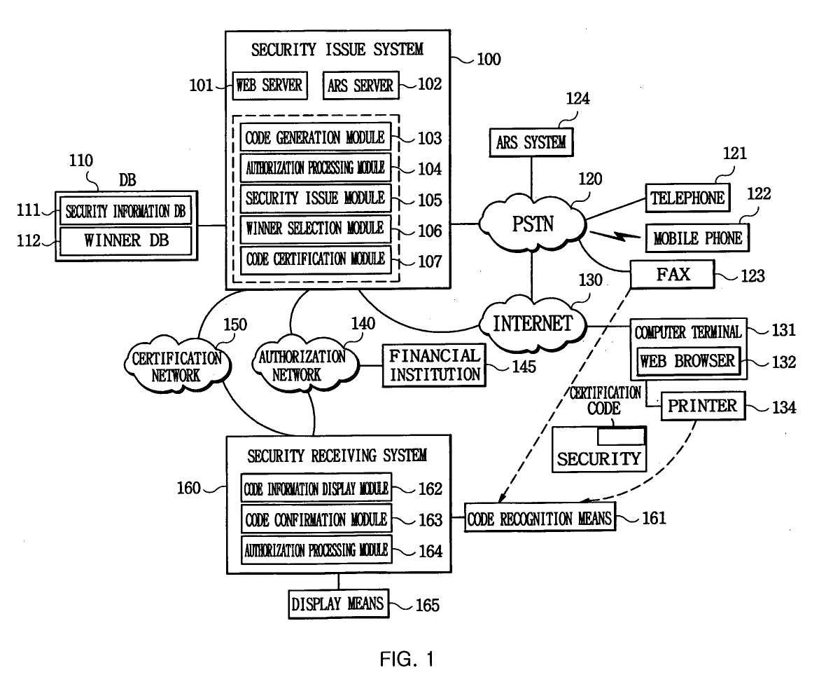

As shown in FIG. 1, the security issuance and distribution system comprises a security issue system 100 which issues securities through the Internet 130 or ARS, an ARS system 124 of a telephony company, a telephone 121 which is connected to the security issue system 100 via a communication network such as PSTN 120, a wireless terminal 122, a FAX 123, a computer terminal for user 131 which is connected to the security issue system 100 via the Internet 130, a security receiving system 160 and a financial institution 145.

The security issue system 100 is a server system which issues securities to the user through an ARS service or Web page and also approves the faithfulness of the securities to the security receiving system 160. The security issue system 100 comprises a basic hardware means such as; a Web server 101 which provides a various type of Web pages required for the issuance of securities and collects certain information necessary for the issuance and authorization of securities, an ARS server 102 which provides voice information pertaining to the issuance of securities in connection with an ARS system 124 and collects certain information necessary for the issuance and authorization of securities, a DB server 110, a communication modem, a processing means and a data management system.

The security issue system 100 is a means for processing the program which issues and certifies securities and comprises, a code generation module 103 which encrypts certain information (user's name, resident registration number, unique security number, issuing institution, issuing time, valid period, issuing purpose) necessary for identifying the security or user (owner) into a dot code or 2D barcode format, an authorization processing module which accepts the cost of the security from the user through a financial institution 145, a security issuing module 105 which issues, the security with contains the code generated from the code generation module 103, through a FAX 123 or the user's computer, a lottery selection module 106 which selects the lottery winners through a predefined method in case a lottery type securities are issued, a code certification module 107 which certifies the faithfulness of the security information through a DB server 110 when the security receiving system 160 requests a certification of the uniqueness/owner of the security, and other application programs which are required for processing Web, ARS and membership management.

The DB server 110 further comprises a security information DB 111 which contains not only the membership and users information but also certain information on users and securities which is necessary for determining the faithfulness of the securities, and a winner DB 112 which stores the information of the winners, identification of lottery type securities and lottery prize.

The identification information for a user (owner) and security includes the name of user, resident registration number, address, personal records, type of security, unique security number, issuing institution, issuing time, valid period, issuing purpose.

The above securities can exist in many types such as a lottery, betting ticket, gift certificate, lottery type security, theater/movie ticket, transportation ticket, various type of nameless securities which can be converted to cash and various type of securities which are being issued from the Internet or other communication networks.

The security issue system 100 can issue these securities either separately or in combination according to the type of the user's online service type.

In case of the securities being requested through an ARS service, the necessary information (user personal records, type of securities, issuing purpose, lottery number selection in case the securities are a lottery type) which are required for issuing and certifying the securities are provided to the ARS system 124 through a telephone 121, wireless terminal or mobile phone 122.

In case of the securities being requested through the Internet, the necessary information as stated above which are required for issuing and certifying the securities are provided to the security issue system 100 through a computer terminal with a communication model, processing means, storage means and Web browser 132, telephone 131, wireless mobile terminal 122. Consequently, the security issue system 100 issues the requested securities through the user's FAX 123 or sends the securities to the user's e-mail address where the user can download them to a computer terminal 131 and outputs the securities through a printer 134.

The security receiving system 160 is a computer system belonging to a receiving institution (or company) which accepts the corresponding securities as the cost of the services and goods provided and authorizes the winning prize or price after checking the faithfulness or winning status in connection with the security issue system 100.

For this purpose, the security receiving system 160 comprises hardware apparatus such as a communication model, data processing and storage means, code recognition means 161 for recognizing the encrypted code contained in the securities, and a display means for displaying the code information and faithfulness to the registered users.

The security receiving system 160 also comprises application program means such as a code information display modules 162 for displaying the internal information of the recognized code by the code recognition means, a code confirmation module 163 for transmitting the decrypted code information (unique number, user (owner) information, etc.) in connection with the security issue system 100 and for confirming the faithfulness of the securities and the wining status for lottery type securities, and an authorization processing module 164 for accepting the payment of the cost through a financial institution for the case of faithful securities or wining securities or for paying the wining prize.

The security receiving system 160 is connected to the security issue system 100 through a certification network in order to find out the uniqueness and faithfulness of the registered securities and is also connected to an account of the corresponding financial institution 145 through an authorization network 140 in order to authorize the cost of the purchase and winning prize.

As far as the online issuance service is concerned, the security issue system 100 can be implemented in conjunction with the Internet postage stamp service which is about to be introduced.

The code of an Internet postage stamp can be encrypted with the certification code information of the above security or lottery type security. This can contribute to an active growth of the Internet postage stamp service and also enables the granting of the ownership or winning entitlement of the security (the security contained in the Internet postage stamp) either to a sender or receiver of the post according to the user's selection.

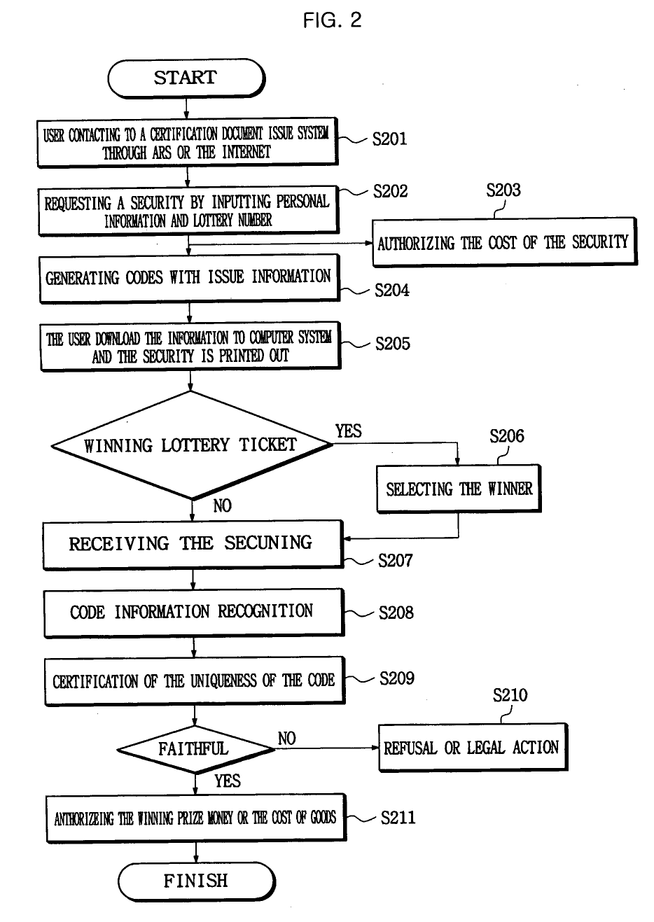

FIG. 2 is a flow diagram which shows the distribution process of the various type of securities as mentioned above. As shown in FIG. 2, the user connects S201 to the security issue system 100 through a communication network such as ARS service, the Internet 130 or other communication networks. Afterwards, the user inputs certain user information pertaining to issuance and certification of the security (name, address, resident registration number, E-mail address, FAX number, telephone number), the type of security to be issued, and the lottery number if the security is a lottery type and requests an issuance of the corresponding security S202. The security issue system 100 authorizes the cost of the issuance of the corresponding security based on a predefined cost authorization method S203 and encrypts the information necessary for checking the faithfulness of the security, the type of the security, issuing institution, issuing date, valid period and the purpose of the issuance into a dot code or 2D barcode S204.

After the issuance of the security with the above codes, the security is issued to the user through a FAX 123 upon a request or the corresponding data for the security is transmitted to an e-mail address of the user. The user can download the information to his/her computer system and the security is subsequently printed out to be used S205.

In case of a lottery type security, the security issue system 100 draws lottery winners through a predefined method and informs the winners through a telephone, e-mail or winner's Web page about the winning status and winning prize S206. Also, the owner of the security submits the printed out security to a security receiving institution (or company) as a authorizing means for the goods and services provided or for the winners of the lottery type security submits the corresponding security to a post office or financial institution in order to receive the wining prize money S207.

Accordingly, the security receiving system 160 decrypts the codes contained in the security through the code recognition means 161 S208 and confirms the uniqueness and faithfulness of the security by transmitting the unique number, issue number and user information to the security issue system 100. Also, by comparing the code recognition information with the inside text of the security, the existence of forgery/alteration is determined S209.

If the security is found out to be unfaithful through the step S209, the receiver can refuse the security and pursue a legal action towards the user S210. If the security is determined to be a faithful one, then the security receiving system 160 can either authorize the cost of the goods and services provided or pay out the winning prize money for the lottery type of security S211.

Among the above securities, in case of the tickets for theater, movie and live performance of which the usage of the security is specifically determined by the location and time of the performance, the security receiving system 160 can download the information (user information, security identification information) from the security issue system 100 and certified the faithfulness of the security therefore reducing the load on the Web server as well as shortening the processing time.

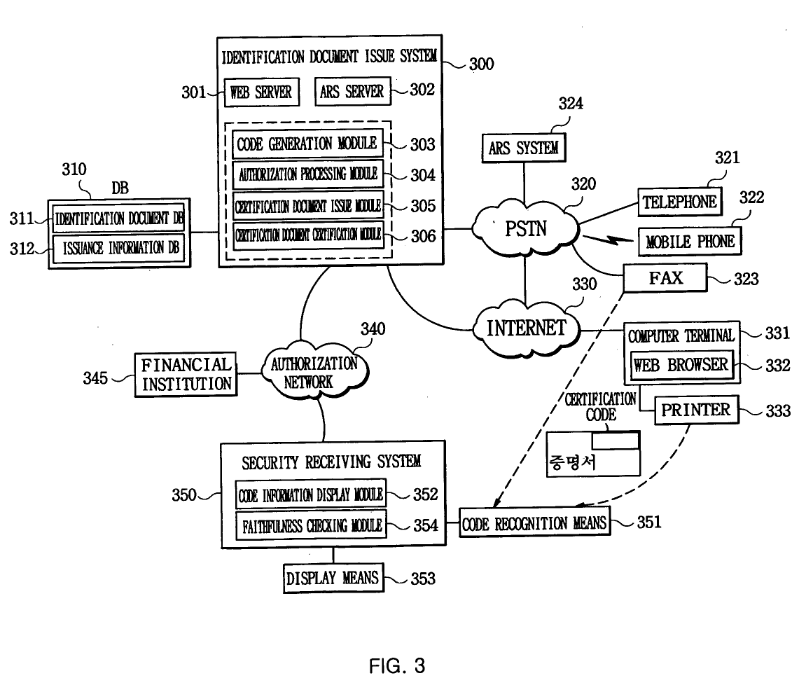

As shown in FIG. 3, the issuance and distribution systems for various identification documents comprises an identification document issue system 300, identification document receiving system 350, ARS system 324 for a telephony company, the Internet 320, authorization network 340. As a means for requesting or printing of the identification documents by the user or a financial institution, the system comprises a telephone 321, wireless terminal 322, computer terminal 331, FAX 323 and printer 333.

The identification document issue system 300 is a server system which operates either in connection with schools, government and offices or directly by schools and government online in order to carry out an identification document issuance service. The identification document issue system 300 comprises a communication modem, data processing means, Web server 301 for providing an identification document issuance service to the user through the Internet, ARS server 302 for providing an ARS identification document issuance service to the user in connection with the ARS system 324 and DB server.

The DB server further comprises an identification document DB 311 for maintaining various identification information of students and citizens as a database according to the service classification, and an issuance information DB 312 for storing and maintaining the information (user information, identification document unique number, issuing date, issuing purpose) pertaining to the issued identification documents.

The identification document issue system 300 comprises a code generation module 303 for encrypting the user (owner) identification information and other important information, an authorization processing module 304 for authorizing the cost of issuance of the corresponding identification document for the user through an online financial institution 345 and authorization network 340, an identification issuing module 305 for issuing the identification document which contains the generated codes through a FAX 323, user's Web address or e-mail address according to the request of the user, an identification certification module 306 for certifying the owner and contents of the received identification documents in the identification receiving system in reference to the issuance information DB 312 and a program module for processing of other Webs and ARS.

Also, the identification document issue system 300 allocates a cost authorization account in an online financial institution and authorizes the received money from the user through a authorization network.

The above identification documents include resident registration documents, seal registration, proof of tax payment, certificate of graduation, certificate of academic record for the students.

Also, as illustrated in FIG. 1, the user can either request issuance of an identification document to the identification document issue system 300 through the ARS server 302 or ARS system 324 via a telephone 321, wireless terminal 322 or public telephone network such as PSTN 320, or to the Internet 330 via mobile Internet wireless terminal 322.

As a printing means, the user has a FAX 323 which is connected to the identification document issue system 300 through a PSTN network 320 or a printer which is connected to the computer terminal 331.

The identification document receiving system 350 is a computer system which receives necessary identification documents form companies, offices, schools, and government and comprises a code recognition means 351 for decrypting the encrypted information contained in the identification documents, a code information display module 352 for displaying the decrypted information (user, important identification information) to the receiver, a faithfulness checking module 354 for checking the faithfulness of the identification document by transmitting to the identification document issue system 300 and a display module 353.

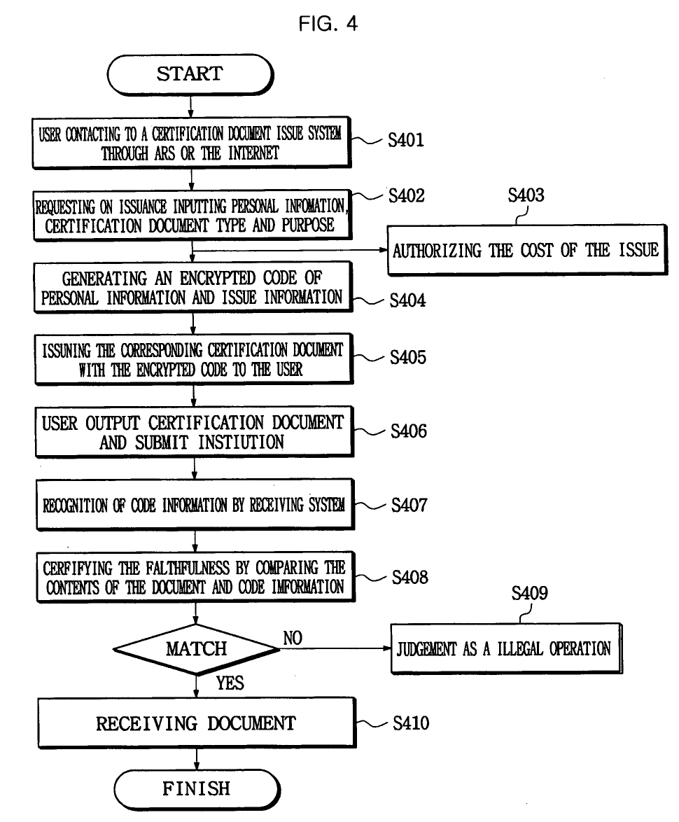

As shown in FIG. 4, the distribution and certification processes of various type of identification documents using the above identification document distribution system involves connecting S401 to ARS service, Internet 330 or other communication networks by the user and providing the information such as personal information (name, resident registration number, student number, address, e-mail address, FAX number, etc.), type of identification document, purpose and outputting means (FAX, e-mail, Web address) in order to request an issuance of an identification document.

The identification document issue system 300 authorizes the cost of issuance of an identification document through a predefined authorization method S403.

After the cost authorization, the identification document issue system 300 encrypts the user recognition information (user name, resident registration number, or student number, etc.) and identification information (major identification list, issuing date, purpose, etc.) into codes S404 and the codes are attached to the corresponding document which is then directly printed out through a FAX, E-mail, or Web page (S405).

Accordingly, the user prints out the document through a FAX 323 or printer 333 and submits the printed identification document to the requested company or institution S406.

After the identification document receiving system 350 decrypts the codes contained in the identification document S407 through the code recognition means 351, the important information (user and identification contents) is transmitted to the identification document issuing system to check the faithfulness of the document and the code information is displayed in order to allow the receiver to confirm the faithfulness of the information pertaining to the user and identification contents S408. If the identification document is found out to be unfaithful through the identification document issuing system, the receiver can refuse the identification document and pursue a certain legal action towards the user S409. If the identification document is found out to be faithful then the corresponding document is received S410.

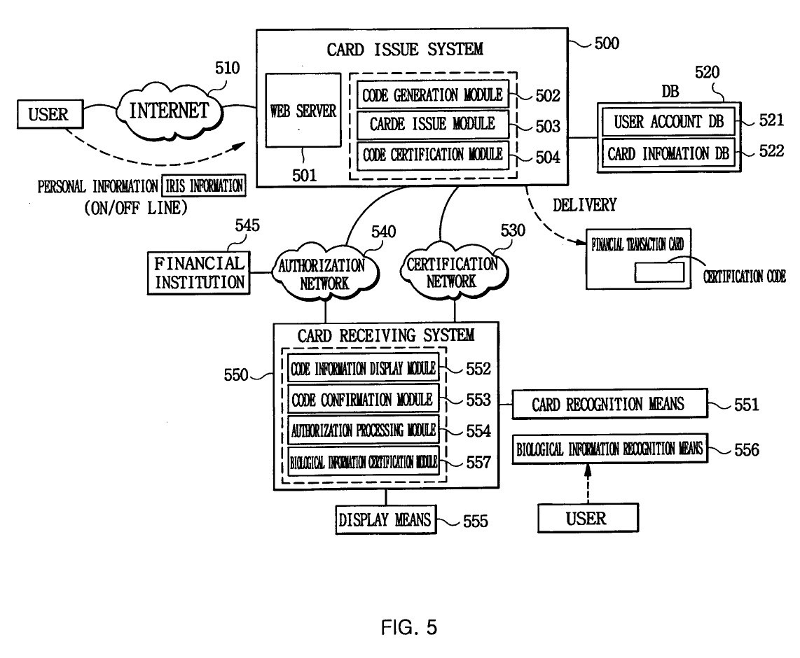

FIG. 5 is a block diagram which shows the distribution process of a financial transaction card with certification codes.

As shown in FIG. 5, the financial card distribution system according to the present invention comprises a card issue system 500 and card receiving system 550. In order to find out the faithfulness of a card, the card receiving system 550 and card issue system 500 are interconnected and the card bill is authorized through a authorization network 540 and online financial institution 545. The user either transmits the personal and biological information online to the card issue system 500 through the Internet 510 or requests issuance of a financial card by providing the same information offline.

The biological information is a means for uniquely identifying a user which might includes a facial image information, fingerprint, iris and voice. The card issue system 500 comprises a number of program modules such as a code generation module 502 for encrypting the information pertaining to user identification, card certification and authorization (user personal information, iris information, unique card number, card issuing institution, authorizing financial institution, authorization account), a card issue module 503 for producing a financial card which contains the above codes and dispatching to the user, a code certification module 504 for certifying the faithfulness of the card in connection with the card receiving system 550, and a DB server.

The DB server further comprises a user account DB 521 for maintaining the information pertaining to the user's online financial account and a card information DB 522 for storing and maintaining the information pertaining to issued financial cards.

Also, the card issue system 500, which comprises a Web server 501 can provide a card issue service through the Internet, and obtain the issue request information, user information and biological information.

By receiving a card with the above certification code, the user can use this for a authorization means for the bill incurred.

The card receiving system 550 comprises a card recognition means 551 for decrypting the code information on the card which is submitted by the user, a biological information recognition means 556 for directly obtaining and decrypting the user's biological information such as a fingerprint, iris and voice, a code information display module 552 for displaying the decrypted code information (name, resident identification number, biological information), a code confirmation module 553 for confirming the faithfulness/uniqueness of the received financial card by sending the code information to the card issue system 500, a biological information certification module 557 for determining the faithfulness by comparing the user biological information from the biological information recognition means 556 and the biological information stored as codes, a authorization processing module for authorizing the bill when the faithfulness of the card is confirmed through the code confirmation module 553 and biological information certification module 557 and a display means 555.

Hence, the card receiver in connection with the card issue system 500 can utilize the method of determining the faithfulness of the code and user, the method of confirming biological information through a fingerprint, iris and voice, the method of comparing the user's codified visual information with the information directly obtained from the user. This can effectively prevent illegal uses as a result of theft/loss or unauthorized operation.

In case of identification documents such as a resident registration document, driver's license, passport, the issuing institution can encrypt the user's name address, resident registration document, unique card number, user's visual information and attach them to the identification document. As a result, the task of identifying a user can rapidly carried out and also effectively prevent the forgery/alteration identification documents.

Also, the medical insurance card issuing institution can encrypt the user information, unique card number, card version information (upgrade version information, valid period) and attach them to medical insurance cards. By frequently upgrading the version of the codes and issuing them through the Internet or post and enforcing the user to attach the upgraded codes, the medical service providers which are requesting the medical bills out of invalid medical cards can easily be identified.

According to the present invention as described so far, various type of securities (lottery ticket, betting ticket, performance ticket, gift certificate) and identification documents can be directly issued to a user's computer thereby unrestrained by the time and location.

Also, the user's concern about the loss and theft of securities or identification documents can be minimized and they can be re-printed or re-issued according to the user's need. The ownership problem of securities can be easily avoided.

Also, the forgery/alteration of identification documents can be effectively prevented and the economic loss stemming from the loss or theft can be reduced.

Finally, the medical service providers which are requesting the medical bills out of invalid medical cards can easily be identified.

It should be understood that the detailed description and specific examples are given by way of illustration only, since various changes and modifications within the spirit and scope of the invention will become apparent to those skilled in the art from this detailed description.

8. A method of preventing an unauthorized use of forgery/alteration of the contents of securities issued by communication networks in which securities are issued to the users through the Internet or ARS and the faithfulness of the contents are authenticated, comprising the steps of:
receiving an issuance request of a security by a security issue system from a user via a communication network after obtaining some information about the owner and the requested security;
authorizing the cost of the issuance of said security by said security issue system through an online financial institution;
constructing a database of the ownership and requested security after encrypting the information pertaining to the uniqueness of said security and identification of the owner and issuing said security to the user;
outputting said issued security by the user via a communication network; and
authenticating the faithfulness of the security and the owner of said security by a security receiving system in terms of recognizing the code of said security in connection with said security issue system via a computer network.

9. The method as claimed in claim 8, wherein said security issue system is issuing a lottery type security, comprising the steps of:
drawing lottery winners through a predefined drawing method and constructing a database containing this information;
certifying the winning status and the faithfulness of said security by said security receiving system by recognizing the codes of said lottery type security in connection with said security issue system after the user receives said lottery type security in order to claim the winning prize money; and
paying out the corresponding winning prize money to the user after confirming the faithfulness of the winner and the security.

10. The method as claimed in claim 8, wherein said security issue system encrypts the certification code information of the said security with the code of an Internet postage stamp and as the user grants the ownership of the security either to a sender or receiver of the post, the corresponding information is attached to the Internet postage stamp.

11. The method as claimed in claim 9, wherein said security issue system encrypts the certification code information of the said security with the code of an Internet postage stamp and as the user grants the ownership of the security either to a sender or receiver of the post, the corresponding information is attached to the Internet postage stamp.

12. A method of preventing an unauthorized use or forgery/alteration of the contents of a certification document issued by communication networks in which certification documents are issued to the users through the Internet or ARS and the faithfulness of the contents are authenticated, comprising the steps of:
receiving an issuance request of a security by a certification document issue system from a user via a communication network after obtaining some information about the owner and the requested certification document;
authorizing the cost of issuance of said document from the user through an online financial institution;
issuing said document to the user in which the essential contents of certification and user information are encrypted;
outputting said issued certification document by the user via a communication network; and
determining the faithfulness of the encrypted information and text by a certification document receiving system by recognizing the encrypted information in connection with said certification document issue system.

13. A means for preventing an unauthorized use or forgery/alteration of an identification document is attached to an encrypted code pertaining to a user's personal and biological information.

14. A means for preventing an unauthorized use or forgery/alteration as claimed claim 13, further comprises a financial transaction card with certification codes having an encrypted information pertaining to user information, financial transaction account and user's biological information are attached and at the time of usage, the encrypted code is decrypted by a code recognition means and the faithfulness is determined by a issuing system through a comparison between the codified biological information on the card and the biological information directly obtained from the user.

15. A means for preventing an unauthorized use or forgery/alteration as claimed claim 13 further comprises a medical insurance card with certification codes in which an encrypted code pertaining to user information, card information and version information are attached.
